(19) United States
(12) Patent Application Publication
(10) Pub. No.: US 2020/0189462 A1
(43) Pub. Date: Jun. 18, 2020

(54) IN-VEHICLE ACCIDENT PREVENTION DEVICE AND IN-VEHICLE ACCIDENT PREVENTION SYSTEM

(71) Applicant: Keiichi Shimizu, Aichi (JP)

(72) Inventor: Keiichi Shimizu, Aichi (JP)

(73) Assignee: OMRON AUTOMOTIVE ELECTRONICS CO., LTD., Aichi (JP)

(21) Appl. No.: 16/659,182

(22) Filed: Oct. 21, 2019

(30) Foreign Application Priority Data
Dec. 13, 2018 (JP) 2018-233293

(51) Int. Cl. B60Q 9/00

(52) U.S. Cl. CPC B60Q 9/008

(57) ABSTRACT

An in-vehicle accident prevention device includes: an occupant detection unit that detects an occupant inside a vehicle; an abnormality detection unit that detects an abnormality in the vehicle; and a control unit that controls a warning device to warn an inside or an outside of the vehicle or controls on-vehicle equipment to mitigate the abnormality when the occupant detection unit detects the occupant and the abnormality detection unit detects the abnormality. The occupant detection unit extracts physical characteristics or behavioral characteristics of the occupant to further detect a type of the occupant or whether or not the occupant is able to cope with the abnormality. The control unit executes the warning by the warning device and the abnormality mitigation by the on-vehicle equipment according to a result of the detection by the occupant detection unit.

### CROSS-REFERENCES TO RELATED APPLICATIONS

This application is based upon and claims the benefit of priority from Japanese Patent Application No. 2018-233293, filed on Dec. 13, 2018; the entire contents of which are incorporated herein by reference.

### FIELD

One or more embodiments of the present invention relate to an in-vehicle accident prevention device that prevents an accident of an occupant left in a vehicle in an abnormal state, and an in-vehicle accident prevention system including the device.

### BACKGROUND

An in-vehicle accident prevention device has been known which prevents an accident by ensuring safety of an occupant left in a vehicle in an abnormal state, in a case where an abnormal state occurs in the vehicle, such as a case where an interior of the vehicle becomes abnormally hot or cold and a case where the interior of the vehicle is filled with toxic gas (see JP-B-5201531, JP-A-2017-218032, and U.S. Pat. No. 9,227,484).

The in-vehicle accident prevention device detects presence of the occupant in the vehicle based on, for example, an image captured by a camera, output signals from sensors that detect a living body, or a sound detected by a microphone. Further, an abnormal state in the vehicle is detected based on the output signals from the sensors that detect a temperature, a humidity, a CO (carbon monoxide) concentration, and the like. When the occupant is left in the vehicle in the abnormal state, a warning device warns the inside and the outside of the vehicle or operates on-vehicle equipment to mitigate the abnormal state in the vehicle.

The warning device includes an in-vehicle warning device such as a display, a lighting device, and a speaker for visually or audibly warning the occupant in the vehicle and an out-vehicle warning device such as a lighting device, a horn, and a communication device for visually or audibly warning a person outside the vehicle. The on-vehicle equipment that mitigates the abnormal state in the vehicle includes an opening and closing control device that opens and closes an opening and closing body such as a vehicle, an air conditioner for the inside of the vehicle, and the like.

In JP-B-5201531, according to the detected duration of the abnormality in the vehicle, a notification to a management center via a communication network, a notification from the management center to a registered mobile terminal, a rescue contact to a predetermined group, and a remote manipulation of mitigating the abnormality by the on-vehicle equipment are executed in stages.

In JP-A-2017-218032, when the occupant is left in the vehicle in the abnormal state, an alerting (an in-vehicle alerting) is first given to the corresponding occupant. Then, when a response manipulation by the occupant is accepted, measures of the warning and abnormality mitigation are not performed. Only when the response manipulation is not accepted, a rank of an emergency degree of the abnormality is determined, and the warning to the outside of the vehicle and the abnormality mitigation by the on-vehicle equipment are executed according to the rank

In U.S. Pat. No. 9,227,484, it is detected whether or not the occupant including a child and a pet is left in the vehicle, based on an image of the occupant' face captured by a camera and output signals from a sound sensor, a CO₂ (carbon dioxide) sensor, and a motion sensor, and the like. When the occupant is left in the vehicle and the temperature inside the vehicle becomes abnormal, the warning to the inside and the outside of the vehicle and the abnormality mitigation by the on-vehicle equipment are executed.

### SUMMARY

In the related art, even when any occupant exists in the vehicle, when the inside of a vehicle becomes abnormal, a warning to the inside or the outside of the vehicle by a warning device or abnormality mitigation by on-vehicle equipment has been executed automatically. Therefore, for example, when a healthy adult, who can detect abnormality in the vehicle and can escape from the vehicle to the outside, exists in the vehicle, it is less necessary to execute the warning or the abnormality mitigation. However, as the warning device or the on-vehicle equipment may be driven, the warning may become noise or electric power of a battery of the vehicle may be consumed. Further, as in JP-A-2017-218032, when a response manipulation is received from the occupant in the vehicle, in a case where the warning to the outside of the vehicle and the abnormality mitigation by the on-vehicle equipment are not executed, for example, in a case where the occupant who cannot escape from the vehicle to the outside by himself/herself accidentally performs the response manipulation, the occupant cannot be rescued and an accident may occur in the vehicle.

An object of one or more embodiments of the present invention is to provide an in-vehicle accident prevention device and an in-vehicle accident prevention system, which can appropriately perform warning or abnormality mitigation according to an occupant left in a vehicle in an abnormal state,

An in-vehicle accident prevention device according to one or more embodiments of the present invention includes: an occupant detection unit that detects an occupant inside a vehicle; an abnormality detection unit that detects an abnormality in the vehicle; and a control unit that controls a warning device to warn an inside or an outside of the vehicle or controls on-vehicle equipment to mitigate the abnormality when the occupant detection unit detects the occupant and the abnormality detection unit detects the abnormality. The occupant detection unit may extract physical characteristics or behavioral characteristics of the occupant to further detect a type of the occupant or whether or not the occupant is able to cope with the abnormality. The control unit may execute the warning by the warning device and the abnormality mitigation by the on-vehicle equipment according to a result of the detection by the occupant detection unit.

Further, an in-vehicle accident prevention system according to one or more embodiments of the present invention includes the in-vehicle accident prevention device, and a warning device that warns an inside or an outside of a vehicle or on-vehicle equipment that mitigates abnormality in the vehicle.

According to the above description, in the in-vehicle accident prevention device, the occupant detection unit not only detects the occupant in the vehicle but also extracts the physical characteristics or behavioral characteristics of the occupant so as to detect the type of the occupant and whether or not the occupant is able to cope with the abnormality. When the occupant detection unit detects the occupant in the vehicle and the abnormality detection unit detects an abnormal stale in the vehicle, the warning device warns an inside or an outside of the vehicle or the on-vehicle equipment mitigates abnormality of the vehicle, according to the type or the state of the occupant detected by the occupant detection unit. Therefore, according to the occupant left in the vehicle in the abnormal state, the warning or the abnormal mitigation can be properly performed.

For example, when the occupant left in the vehicle in the abnormal state is a healthy adult who can detect the abnormality and perform appropriate measures such as escaping from the vehicle to the outside by himself/herself, the warning by the warning device and the abnormality mitigation by the on-vehicle equipment are not executed. Accordingly, it is possible to suppress consumption of a battery for driving the warning device and the on-vehicle equipment, and to suppress a state in which the warning becomes noise. Further, when the occupant left in the vehicle in the abnormal state is an infant or the like who cannot cope with the abnormality by himself/herself, the warning by the warning device or the abnormality mitigation by the on-vehicle equipment is executed, so that the occupant is rescued and thus an accident in the vehicle can be prevented.

In one or more embodiments of the present invention, in the in-vehicle accident prevention device, when the occupant detection unit detects that the occupant in the vehicle cannot cope with the abnormality, the control unit executes the warning for the outside of the vehicle by the warning device or executes the abnormality mitigation by the on-vehicle equipment.

Further, in one or more embodiments of the present invention, in the in-vehicle accident prevention device, the abnormality detection unit may repeatedly detect a plurality of types of abnormality in the vehicle, and the control unit may execute the warning by the warning device or the abnormality mitigation by the on-vehicle equipment, according to a result of the detection by the abnormality detection unit.

Further, in one or more embodiments of the present invention, in the in-vehicle accident prevention device, there are a plurality of warning operations by the warning device or a plurality of abnormality mitigation operations by the on-vehicle equipment, and the control unit may determine a danger level in the vehicle based on the results of the detection by the occupant detection unit and the abnormality detection unit, and may select a predetermined operation among the plurality of warning operations or the plurality of abnormality mitigation operations according to the danger level.

Further, in one or more embodiments of the present invention, the in-vehicle accident prevention device further includes a wireless communication unit that is mounted on the vehicle to communicate with the portable device carried by a user of the vehicle, in which the control unit may communicate with the portable device by the wireless communication unit, and alerts the user by an alerting unit provided in the portable device according to results of the detection by the occupant detection unit and the abnormality detection unit.

Further, in one or more embodiments of the present invention, the in-vehicle accident prevention device further includes a position detection unit that detects the position of the portable device based on a communication state with the portable device by the wireless communication unit, in which the control unit may executes the alerting by the alerting unit when the occupant detection unit detects that the occupant in the vehicle is not able to cope with the abnormality and it is determined that the portable device is separated from the vehicle, based on a result of the detection by the position detection unit.

Further, in one or more embodiments of the present invention, in the in-vehicle accident prevention device, the control unit may estimate a time, during which the user carrying the portable device can return to the vehicle, from the position of the portable device outside the vehicle detected by the position detection unit, and may execute the alerting by the alerting unit, the warning by the warning device, or the abnormality mitigation by the on-vehicle equipment, according to the time.

Further, in one or more embodiments of the present invention, in the in-vehicle accident prevention device, the control unit may estimate a time until the abnormality reaches a predetermined emergency level, based on the results of the detection by the occupant detection unit and the abnormality detection unit, and may execute the alerting by the alerting unit, the warning by the warning device, or the abnormality mitigation by the on-vehicle equipment according to the time.

Further, in one or more embodiments of the present invention, in the in-vehicle accident prevention device, the warning device may include an in-vehicle warning device that warns the occupant in the vehicle that the vehicle is abnormal, and an out-vehicle warning device warns the outside of the vehicle that the occupant is left in the vehicle that is abnormal, and the on-vehicle equipment may include an opening and closing body control device that opens and closes an opening and closing body of the vehicle or an air conditioner that air-conditions the inside of the vehicle.

According to one or more embodiments of the present invention, an in-vehicle accident prevention device and an in-vehicle accident prevention system, which can appropriately perform warning or abnormality mitigation according to an occupant left in a vehicle in an abnormal state, can be provided.

### BRIEF' DESCRIPTION OF DRAWINGS

FIG. 1 is a schematic view of an in-vehicle accident prevention system according to an embodiment of the present invention.

FIG. 2 is a schematic view of an in-vehicle accident prevention device of FIG.

FIG. 3 is a flowchart illustrating an operation of the in-vehicle accident prevention device of FIG. 1.

FIG. 4 is a diagram illustrating a high temperature abnormality table stored in the in-vehicle accident prevention device of FIG. 1.

FIG. 5 is a diagram illustrating a low temperature abnormality table stored in the in-vehicle accident prevention device of FIG. 1.

FIG. 6 is a diagram illustrating a CO abnormality table stored in the in-vehicle accident prevention device of FIG. 1.

FIG. 7 is a diagram illustrating an inundation abnormality table stored in the in-vehicle accident prevention device of FIG. 1.

FIG. 8 is a diagram illustrating a traffic accident abnormality table stored in the in-vehicle accident prevention device of FIG. 1.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Hereinafter, embodiments of the present invention will be described with reference to the accompanying drawings. In the drawings, the same or corresponding portions are designated by the same reference numerals.

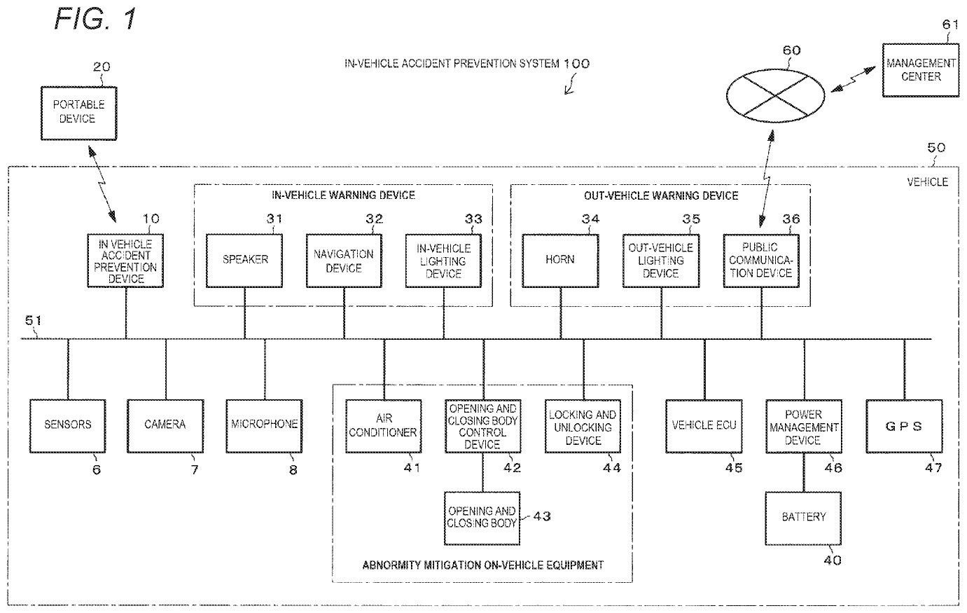

FIG. 1 is a schematic view of an in-vehicle accident prevention system 100 according to the present embodiment of the present invention. The in-vehicle accident prevention system 100 includes an in-vehicle accident prevention device 10, a portable device 20, blocks 31 to 36 constituting a warning device, and blocks 6 to 8 and 41 to 47 constituting the on-vehicle equipment, and a battery 40. Among them, the portions other than the portable device 20 are mounted on a vehicle 50 that is a four-wheeled vehicle, and are driven by electric power of the battery 40.

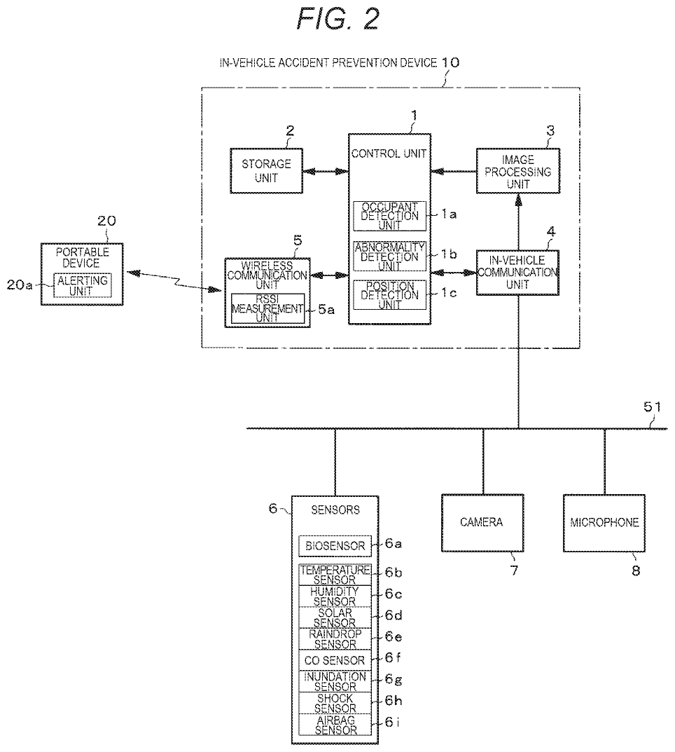

The in-vehicle accident prevention device 10 is electrically connected to a communication bus 51 provided in the vehicle 50. Details of the in-vehicle accident prevention device 10 will be described below (FIG. 2).

The portable device 20 includes an FOB key carried by a user such as a driver of the vehicle 50, a smartphone, and the other wearable devices. The portable device 20 is driven by electric power of a built-in battery.

A speaker 31, a navigation device 32, an in-vehicle lighting device 33, a horn 34, an out-vehicle lighting device 35, and a public communication device 36 constitute the warning device, and are electrically connected to the communication bus 51.

The speaker 31 outputs a voice to the inside (the vehicle interior) of the vehicle 50. The navigation device 32 is installed in the vehicle and has a display for displaying an image. The in-vehicle lighting device 33 includes a light, an LEI), and the like provided in the vehicle. The horn 34 outputs a sound to the outside of the vehicle 50. The out-vehicle lighting device 35 includes a light, an LED, and the like provided outside the vehicle. The public communication device 36 communicates with a management center 61 via a public communication network 60 such as the Internet and a telephone line. The management center 61 notifies a warning to a predetermined group that performs a rescue operation such as a fire station and a police station when the vehicle 50 is in an emergency situation.

The speaker 31, the navigation device 32, and the in-vehicle lighting device 33 are in-vehicle warning devices that audibly or visually warn the inside of the vehicle. The horn 34, the out-vehicle lighting device 35, and the public communication device 36 are out-vehicle warning devices that audibly or visually warm the outside of the vehicle.

The sensors 6, the camera 7, the microphone 8, the air conditioner 41, the opening and closing body control device 42, the opening and closing body 43, the locking and unlocking device 44, the vehicle ECU (an electronic control device) 45, the power management device 46, and the global positioning system (GPS) 47 constitute the on-vehicle equipment. Among them, the portions other than the opening and closing body 43 are electrically connected to the communication bus 51.

The sensors 6 detect biometric information of the occupant in the vehicle and in-vehicle environment information. Details of the sensors 6 will be described below (FIG. 2). The camera 7 captures an image of the inside of the vehicle. The microphone 8 converts a sound in the vehicle into an electric signal.

The air conditioner 41 includes an air conditioner and an air purifier that air-conditions the inside of the vehicle. The opening and closing body 43 includes a window and a door provided at each seat of the vehicle 50 and a mechanism that opens and closes the window and the door. The locking and unlocking device 44 includes a circuit and a mechanism that locks and unlocks each door. The opening and closing body control device 42 controls an opening and closing operation of the opening and closing body 43 and the locking and unlocking of each door by the locking and unlocking device 44. Further, the opening and closing body control device 42 detects an opening and closing position, a fully opened state, and a fully closed state of the opening and closing body 43, based on an output from an opening and closing body position sensor that is not illustrated. The air conditioner 41, the opening and closing body control device 42, the opening and closing body 43, and the locking and unlocking device 44 are on-vehicle equipment for mitigating abnormality in the vehicle.

The vehicle ECU 45 detects a traveling or stopping state of the vehicle 50, detects a driving or stopping state of a travelling drive source such as an engine, and detects an on or off manipulation state of a power switch. The power management device 46 manages power of the battery 40 and detects an on or off state of a power source of the vehicle 50. The GPS 47 detects the position of the vehicle 50,

FIG. 2 is a schematic view of the in-vehicle accident prevention device 10.

The in-vehicle accident prevention device 10 includes an ECU. The in-vehicle accident prevention device 10 includes a control unit 1, a storage unit 2, an image processing unit 3, an in-vehicle communication unit 4, and a wireless communication unit 5.

The control unit 1 includes a CPU and a memory. The control unit 1 is provided with an occupant detection unit la, an abnormality detection unit 1b, and a position detection unit 1 c. The storage unit 2 includes a memory. The image processing unit 3 includes a circuit that processes an image captured by the camera 7.

The in-vehicle communication unit 4 is a circuit that communicates with other devices 6 to 8, 31 to 36, and 41 to 47 (FIG. 1) mounted on the vehicle 50 through the communication bus 51 by a control unit area network (CAN) or the like. An image signal of the image captured by the camera 7 is input to the image processing unit 3 through the communication bus 51 and the in-vehicle communication unit 4. A sound signal from the microphone 8 and detection signals of the sensors 6 are input to the control unit 1 through the communication bus 51 and the in-vehicle communication unit 4.

As another example, the camera 7 and the image processing unit 3 may be connected to each other by a dedicated wiring, and an image signal may be directly input from the camera 7 to the image processing unit 3. Further, the microphone 8 and the sensors 6 may be connected to the control unit 1 with a dedicated wiring, the sound signal may be directly input from the microphone 8 to the control unit 1, and the detection signals may be directly input from the sensors 6 to the control unit 1.

The wireless communication unit 5 includes a circuit and an antenna that wirelessly transmit and receive a low frequency (LF) signal, an ultra high frequency (UHF) signal, or a bluetooth (registered trademark) low energy (BLE) signal to and from the portable device 20. The wireless communication unit 5 is provided with an RSSI measurement unit 5a that measures a signal reception intensity (RSSI) when a signal transmitted from the portable device 20 is received.

The sensors 6 include a biosensor 6a, a temperature sensor 6b, a humidity sensor 6c, a solar sensor 6d, a raindrop sensor 6e, a CO (carbon monoxide) sensor 6f, an inundation sensor 6g, a shock sensor 6h, and an airbag sensor 6i.

The biosensor 6a detects the biometric information such as a pulse, a heartbeat, a body temperature, a brain wave, and a respiration of the occupant in the vehicle. The biometric information of the occupant in the vehicle is also detected from the image captured by the camera 7 and the sound detected by the microphone 8. In detail, the occupant detection unit 1a of the control unit 1 detects biometric information such as motion (a behavior) of the occupant in the vehicle, motion of a chest interlocked with the respiration of the occupant, and motion of a pupil of the occupant, based on image data of the captured image processed by the image processing unit 3. Further, the occupant detection unit 1a detects the biometric information related to a voice such as a voiceprint of the occupant in the vehicle, based on the sound signal in the vehicle input from the microphone 8.

The occupant detection unit 1a detects whether there is the occupant in the vehicle, based on the image data and the biometric information. Further, when there is the occupant in the vehicle, the occupant detection unit 1a extracts physical characteristics and behavioral characteristics such as a face and a body of the occupant, based on the image data and the biometric information, and detects the type of the occupant and whether or not the occupant can cope with the abnormality in the vehicle, based on the extracted result.

The types of occupants detected by the occupant detection unit 1a include an infant, a pet (an animal such as a dog and a cat), a child, unhealthy adult (a sick or disabled person), and a healthy adult. A response of the occupant to the abnormality in the vehicle includes manipulation that mitigates the abnormality as the abnormality occurring in the vehicle is detected, such as opening and closing the opening and closing body 43 such as a window and a door and operating the air conditioner 41, and actions such as escaping from the inside of the vehicle by himself/herself and requesting a rescue from someone by himself/herself to escape from the abnormality.

The temperature sensor 6b detects an external temperature of the vehicle 50 and a temperature in the vehicle interior. The humidity sensor 6c detects an external humidity of the vehicle 50 and a humidity in the vehicle interior. The solar sensor 6d detects the amount of solar radiation that illuminates the vehicle interior from the window of the vehicle 50. The raindrop sensor 6e detects raindrops attached to a predetermined position on the outer surface of the vehicle 50. The CO sensor 6f detects the CO concentration around the outside of the vehicle 50 and the CO concentration in the vehicle interior. The inundation sensor 6g detects inundation into the vehicle interior. The shock sensor 6h detects a shock received by the vehicle 50. The airbag sensor 6i detects whether or not an airbag of the vehicle 50 is deployed.

The abnormality detection unit 1b of the control unit 1 detects abnormality of an in-vehicle environment, based on results of the detection by the sensors 6b to 6i other than the biosensor 6a. In detail, high temperature abnormality or low temperature abnormality in the vehicle is detected based on the results of the detection by the temperature sensor 6b, the humidity sensor 6c, the solar sensor 6d, and the raindrop sensor 6e. Further, abnormality of the CO concentration around the outside of the vehicle 50 or in the vehicle interior is detected based on a result of the detection by the CO sensor 6f. Further, abnormality of the inundation in the vehicle is detected based on a result of the detection by the inundation sensor 6g. Further, abnormality in the vehicle due to a traffic accident of the vehicle 50 is detected based on results of the detection by the shock sensor 6h and the airbag sensor 6i.

The position detection unit 1c of the control unit 1 detects the position of the portable device 20, based on a communication state with the portable device 20 by the wireless communication unit 5. In detail, the wireless communication unit 5 is provided with a plurality of antennas installed inside or outside the vehicle 50 and an RSSI measurement unit 5a. It is determined whether the portable device 20 is located inside or outside the vehicle 50, based on the communication state with the portable device 20 by the plurality of antennas and information included in a signal received from the portable device 20. When the portable device 20 is located outside the vehicle, a distance from the vehicle 50 to the portable device 20 is calculated based on the signal reception intensity measured by the RSSI measurement unit 5a when the signal from the portable device 20 is received by the antennas.

The portable device 20 is provided with an alerting unit 20a. The alerting unit 20a includes a speaker, an LED, or a display. The alerting unit 20a audibly or visually alerts a user such as a driver of the vehicle 50 carrying the portable device 20.

When the occupant detection unit 1a detects that the occupant exists in the vehicle and the abnormality detection unit 1b detects the abnormality in the vehicle, the control unit 1 controls each of the blocks 31 to 36 constituting the warning device to warn the inside and the outside of the vehicle, controls each of the blocks 41 to 44 constituting the abnormality mitigating on-vehicle equipment to mitigate the abnormality, and communicates with the portable device 20 by the wireless communication unit 5 to perform an alerting by the alerting unit 20a of the portable device 20. Therefore, the portable device 20 is also one warning device.

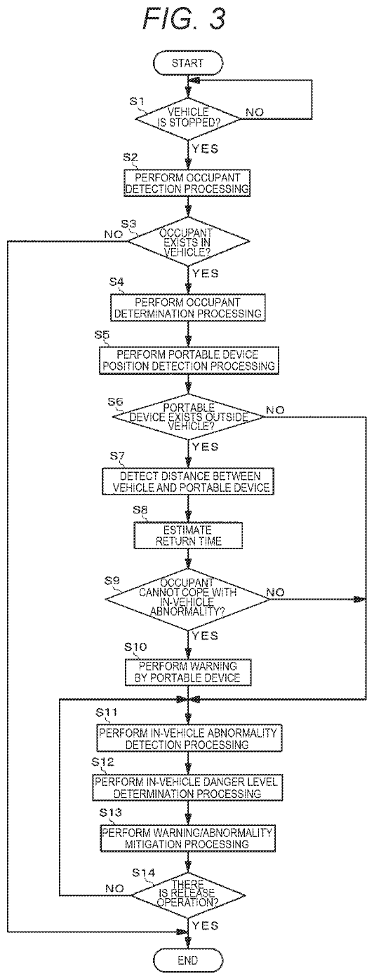

FIG. 3 is a flowchart illustrating an operation of the in-vehicle accident prevention device 10.

The control unit 1 of the in-vehicle accident prevention device 10 detects that the vehicle 50 is stopped (the vehicle 50 is parked and the travelling drive source thereof such as a power source and an engine is stopped), based on information acquired from the vehicle ECU 45 and the power management device 46 (step S1: YES). Then, the occupant detection unit 1a executes occupant detection processing (step S2). At this time, the occupant detection unit 1a detects whether there is the occupant in the vehicle, based on the image data obtained by capturing an image of the inside of the vehicle by the camera 7 and processing the image signal from the camera 7 by the image processing unit 3, a result of the detection by the biosensor 6a, and the sound signal from the microphone 8. Further, the biometric information of the occupant is detected based on the image data, the result of the detection by the biosensor 6a, and the sound signal from the microphone 8.

When the occupant exists in the vehicle (step S3: YES), the occupant detection unit 1a executes occupant determination processing (step S4). At this time, the occupant detection unit 1a extracts the physical characteristics and the behavioral characteristics of the occupant in the vehicle from the image data and the biometric information, and detects the type of the occupant and whether or not the occupant can cope with the abnormality in the vehicle. Further, the number of occupants in the vehicle is also detected.

Next, the control unit 1 executes processing of detecting the position of the portable device 20 (step S5). At this time, the control unit 1 communicates with the portable device 20 by the wireless communication unit 5, and detects whether the portable device 20 exists inside or outside the vehicle by the position detection unit 1c, based on the signal received from the portable device 20. Here, when the portable device 20 is located outside the vehicle (step S6: YES), the control unit 1 determines that the user carrying the portable device 20 goes out from the vehicle 50.

The control unit 1 detects the distance from the vehicle 50 to the portable device 20 by the position detection unit 1c (step S7), and estimates a time during which the user carrying the portable device 20 can return to the vehicle 50 on foot, based on the distance (step S8). Further, when the occupant detection unit 1a detects that the occupant in the vehicle cannot cope with the abnormality in the vehicle (step S9: YES), the control unit 1 communicates with the portable device 20 by the wireless communication unit 5, and alerts the user by the alerting unit 20a of the portable device 20 (step S10). At this time, for example, the alerting unit 20a may generate an alerting sound or an alerting light included in the alerting unit 20a may be turned on. The alerting unit 20a may perform visual or audible alerting indicating that the occupant that cannot cope with the abnormality in the vehicle is left in the vehicle or that the in-vehicle environment may become abnormal.

Next, the abnormality detection unit 1b executes in-vehicle abnormality detection processing (step S11). At this time, the abnormality detection unit 1b detects whether or not the inside of the vehicle has a high temperature abnormality, a low temperature abnormality, a CO abnormality, an inundation abnormality, or a traffic accident abnormality, based on the results of the detection by the sensors 6h to 6i. Further, when the inside of the vehicle has the high temperature abnormality or the low temperature abnormality, the abnormality detection unit 1b estimates a time until the temperature in the vehicle reaches an emergency level (a predetermined emergency high temperature or a predetermined emergency low temperature), based on the results of the detection by the temperature sensor 6b, the humidity sensor 6c, the solar sensor 6d, and the raindrop sensor 6e. Further, when the inside of the vehicle is in an abnormal inundation state, the abnormality detection unit 1b further estimates a time until a living area in the vehicle interior disappears due to inundation, based on a result of the detection by the inundation sensor 6a.

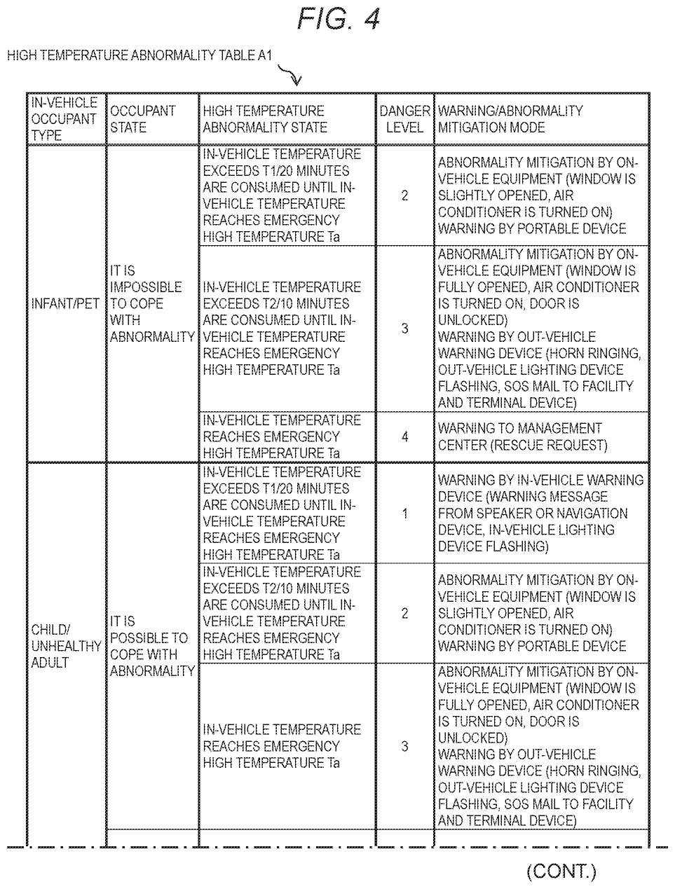

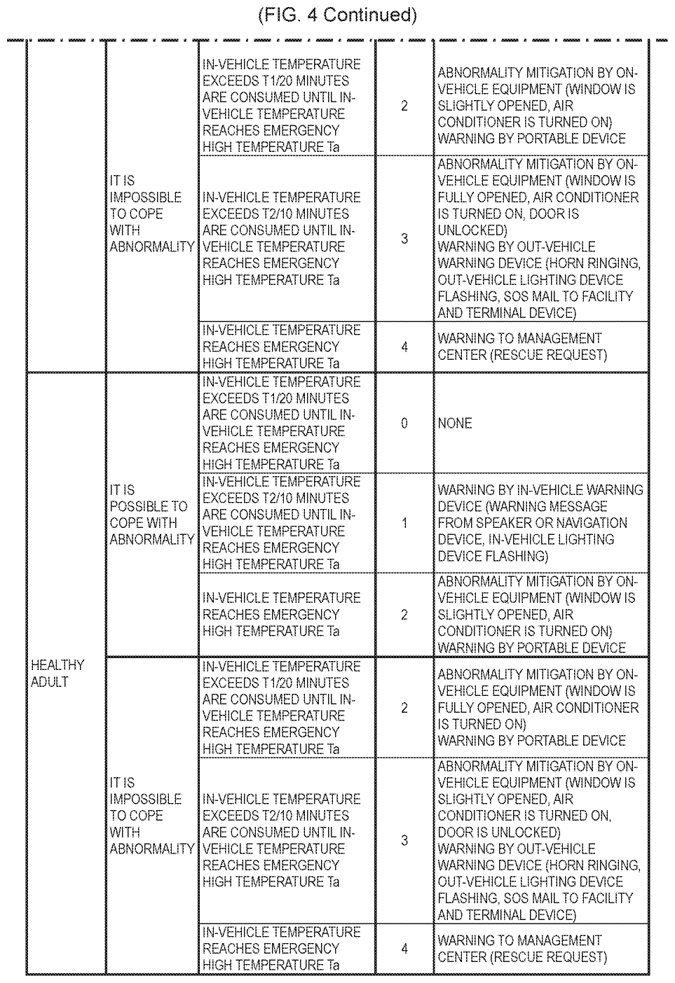

Next, the control unit 1 executes determination processing for a danger level in the vehicle, based on the results of the detection by the occupant detection unit 1a and the abnormality detection unit 1b (step S12). The control unit 1 executes warning and abnormality mitigation processing according to abnormality tables A1 to A5 illustrated in FIGS. 4 to 8 (step S13),

FIGS. 4 to 8 are diagrams illustrating the abnormality tables A1 to A5 stored in the storage unit 2 of the in-vehicle accident prevention device 10. High temperature abnormality

When the abnormality detection unit 1b detects that the inside of the vehicle has the high temperature abnormality in step S11 of FIG. 3, the control unit 1 executes the warning and abnormality mitigation processing of step S13 of FIG. 3, according to the high temperature abnormality table A1 illustrated in FIG. 4. In the high temperature abnormality table A1, the type of the occupant in the vehicle detected in step S4 of FIG. 3, the state of the occupant detected in step S4 (whether or not it is possible to cope with the abnormality), the state of the high temperature abnormality detected in step S11, the danger level for the abnormality state determined in step S12, and the aspect of the warning and abnormality mitigation executed in step S13 are set.

In FIG. 4, for example, when the occupant in the vehicle detected by the occupant detection unit 1a is only an infant or a pet, it is determined that the occupant cannot cope with the abnormality in the vehicle. Then, according to a procedure described below, the control unit 1 determines the danger level in the vehicle according to the high temperature abnormal state detected by the abnormality detection unit 1b, and executes a warning operation or an abnormality mitigation operation according to the danger level,

When the occupant in the vehicle is only an infant or a pet and the occupant cannot cope with the abnormality in the vehicle, if the abnormality detection unit 1b detects that the temperature in the vehicle exceeds a predetermined temperature T1 (for example, 35° C.) or estimates that a time until the temperature in the vehicle reaches the emergency high temperature Ta (for example, 65° C.) is 20 minutes, the control unit 1 determines the danger level as “2”. At the danger level “2”, the control unit 1 opens the window included in the opening and closing body 43 by the opening and closing body control device 42 slightly (by a predetermined amount) or adjusts the temperature in the vehicle to a proper temperature by driving the air conditioner 41. However, when it is detected that there is heavy rain outside the vehicle, based on a result of the detection by the raindrop sensor 6e, the window is not opened. Further, when a residual amount of the battery 40 is less than a predetermined amount, the air conditioner 41 is not driven. Further, at the danger level “2”, the alerting light included in the alerting unit 20a of the portable device 20 is lighted in orange, and the fact that the occupant is left in the vehicle, the type and the state of the occupant, and the time until the temperature in the vehicle reaches an emergency temperature are displayed on a display included in the alerting unit 20a and are notified by the speaker to alert the user. At this time, the time and the number of times of alerting by the alerting unit 20a may be set according to the time, during which the user returns to the vehicle 50, estimated in step S8 of FIG. 3. Further, a driving mode and an adjustment temperature of the air conditioner 41 may be set according to the return time.

Further, when the occupant in the vehicle is only an infant or a pet, if the abnormality detection unit 1b detects that the temperature in the vehicle exceeds a predetermined temperature T2 (for example, 40° C. to 50° C., T2>T1) or estimates, as 10 minutes, the time until the temperature in the vehicle reaches the emergency high temperature Ta, the control unit 1 determines that the danger level is “3”. At the danger level “3”, the control unit 1 fully opens the window by the opening and closing body control device 42 or rapidly decreases the temperature in the vehicle by the air conditioner 41 to adjust the temperature to a proper temperature. However, when it is detected that there is heavy rain outside the vehicle, based on the result of the detection by the raindrop sensor 6e, the window is not opened fully Further, when a residual amount of the battery 40 is less than a predetermined amount, the air conditioner 41 is not driven. Further, at the danger level “3”, the door of the vehicle 50 is unlocked by the locking and unlocking device 44. Further, the horn 34 is sounded to output a warning sound or the out-vehicle lighting device 35 is blinked to request a rescue from a person around the vehicle 50, so as to warn the outside of the vehicle. At this time, the volume and the output frequency of the warning sound from the horn 34 and the flickering period and the brightness of the out-vehicle lighting device 35 may be set according to the time, during which the user returns to the vehicle 50, estimated in step S8 of FIG. 3 and the large number of people at a place where the vehicle 50 is located. Further, the control unit 1 transmits an SOS mail to a facility or a terminal device registered in advance through the public communication device 36 and the public communication network 60.

Further, when the occupant in the vehicle is only an infant or a pet, if the abnormality detection unit 1b detects that the temperature in the vehicle reaches the emergency high temperature Ta, the control unit 1 determines that the danger level is “4”. At the danger level “4”, the control unit 1 warns the management center 61 by a telephone or an e-mail that the occupant is left in the vehicle in an abnormal high temperature state, through the public communication device 36 and the public communication network 60.

At this time, position information of the vehicle 50 detected by the GPS 47, registered specific information of the vehicle 50, an abnormal state in the vehicle, the type, the state, and the image of the occupant in the vehicle, and the like together are notified to the management center 61. The management center 61, which receives such warning and notifications, dispatches a staff member to a site to rescue the occupant from the inside of the vehicle or requests a rescue from a rescue organization such as a fire station and a police station. The contents transmitted to the management center 61 may be changed according to the time, during which the user returns to the vehicle 50, estimated in step S8 of FIG. 3.

As described above, the higher the danger level in the vehicle (the larger the numerical value of the level) is, the higher the danger degree of the occupant in the vehicle is. Thus, the degree of the abnormality mitigation by the on-vehicle equipment 41 to 44 is increased or the warning target by the warning devices 31 to 36 is expanded. Further, when a residual amount of the battery 40 is low, it is preferable that the warning to the outside of the vehicle by the out-vehicle warning devices 34 to 36 is prioritized over the abnormality mitigation by the on-vehicle equipment 41 to 44.

Next, in FIG. 4, when the occupant in the vehicle detected by the occupant detection unit 1a is a child, an unhealthy adult, or a healthy adult, the control unit 1 determines the danger level in the vehicle according to whether or not the occupant can cope with the abnormality and a high temperature abnormality state, and executes the warning operation or the abnormality mitigation operation according to the danger level.

In step S4 of FIG. 3, when the occupant detection unit 1a determines that the occupant in the vehicle is a child or an unhealthy adult, if the occupant is awake and the occupant has no doubtful point, it is determined that the occupant can partially cope with the abnormality. The doubtful point of the occupant is, for example, that the occupant does not move or that the occupant cannot open or close the opening and closing body 43 or cannot get off the vehicle even though the occupant attempts to perform them. Further, a state in which the occupant can partially cope with the abnormality assumes, for example, an action such as opening a door to get off the vehicle and requesting a rescue from someone.

As described above, even when the occupant in the vehicle is a child or an unhealthy adult, in a case where it is determined that the occupant can partially cope with the abnormality in the vehicle, if the temperature in the vehicle exceeds a predetermined temperature T1 or the estimated time until the temperature in the vehicle reaches the emergency high temperature Ta is 20 minutes, the control unit 1 determines that the danger level is “1”. At the danger level “1”, the control unit 1 outputs a warning message by a warning sound or voice from the speaker 31 to the inside of the vehicle, displays the warning message on the display of the navigation device 32, and warns the occupant in the vehicle by causing the in-vehicle lighting device 33 to flicker. The warning message includes, for example, an abnormal stale in the vehicle, a method of mitigating the abnormality, or an escape recommendation from the abnormal vehicle. Further, according to the time, during which the user returns to the vehicle 50, estimated in step S8 of FIG. 3, the number of the driven in-vehicle warning devices 31 to 33 may he set, the contents of the warning message may be changed, and a warning mode by the in-vehicle warning devices 31 to 33 may be changed.

Further, when the occupant in the vehicle is a child or an unhealthy adult, in a case where the occupant can partially cope with the abnormality in the vehicle, if the temperature in the vehicle exceeds a predetermined temperature T2 or the estimated time until the temperature in the vehicle reaches the emergency high temperature Ta is 10 minutes, the control unit 1 determines that the danger level is “2”. Further, when the temperature in the vehicle reaches the emergency high temperature Ta, the control unit 1 determines that the danger level is “3”. After it is determined that the danger level is “2” or “3”, the control unit 1 executes the abnormality mitigation operation or the warning operation corresponding to each danger level, as described above.

Further, when the occupant in the vehicle is a child or an unhealthy adult, if the occupant is sleeping or has the doubtful point, the occupant detection unit 1a determines that the occupant cannot cope with the abnormality in the vehicle. In this case, when the temperature in the vehicle exceeds the predetermined temperature T1 or when the estimated time until the temperature in the vehicle reaches the emergency high temperature Ta is 20 minutes, the control unit 1 determines that the danger level is “2”. Further, when the temperature in the vehicle exceeds the predetermined temperature T2 or when the estimated time until the temperature in the vehicle reaches the emergency high temperature Ta is 10 minutes, the control unit 1 determines that the danger level is “3”. Further, when the temperature in the vehicle reaches the emergency high temperature Ta, the control unit 1 determines that the danger level is “4”. After it is determined that the danger level is “2” to “4”, the control unit 1 executes the abnormality mitigation operation or the warning operation corresponding to each danger level, as described above.

Further, in step S4 of FIG. 3, when the occupant detection unit 1a determines that the occupant in the vehicle is a healthy adult, if the occupant is awake and the occupant has no doubtful point, it is determined that the occupant can cope with the abnormality in the vehicle. In this case, when the temperature in the vehicle exceeds the predetermined temperature T1 or when the estimated time until the temperature in the vehicle reaches the emergency high temperature Ta is 20 minutes, the control unit 1 determines that the danger level is “0”. At the danger level “0”, the control unit 1 does not perform the abnormality mitigation operation by the on-vehicle equipment 41 to 44, the warning operation by the warning devices 31 to 36, and the alerting by the portable device 20. That is, at the danger level “0”, the in-vehicle accident prevention device 10 waits for the occupant in the vehicle to cope with the abnormality in the vehicle by himself/herself.

Further, when the occupant in the vehicle is a healthy adult, in a case where the occupant can cope with the abnormality in the vehicle, if the temperature in the vehicle exceeds the predetermined temperature T2 or the estimated time until the temperature in the vehicle reaches the emergency high temperature Ta is 10 minutes, the control unit 1 determines that the danger level is “1”. As described above, the abnormality mitigation operation and the warning operation corresponding to the danger level “1” are executed.

Further, when the occupant in the vehicle is a healthy adult, in a case where the occupant can cope with the abnormality in the vehicle, if the temperature in the vehicle reaches the emergency high temperature Ta, the control unit 1 determines that the danger level is “2”. As described above, the abnormality mitigation operation and the warning operation corresponding to the danger level “2” are executed.

Further, when the occupant in the vehicle is a healthy adult, if the occupant is sleeping or has the doubtful point, the occupant detection unit 1a determines that the occupant cannot cope with the abnormality. In this case, when the temperature in the vehicle exceeds the predetermined temperature T1 or when the estimated time until the temperature in the vehicle reaches the emergency high temperature Ta is 20 minutes, the control unit 1 determines that the danger level is “2”. Further, when the temperature in the vehicle exceeds the predetermined temperature T2 or when the estimated time until the temperature in the vehicle reaches the emergency high temperature Ta is 10 minutes, the control unit 1 determines that the danger level is “3”. Further, when the temperature in the vehicle reaches the emergency high temperature Ta, the control unit 1 determines that the danger level is “4”. After it is determined that the danger level is “2” to “4”, the control unit 1 executes the abnormality mitigation operation or the warning operation corresponding to each danger level, as described above.

### Low Temperature Abnormality

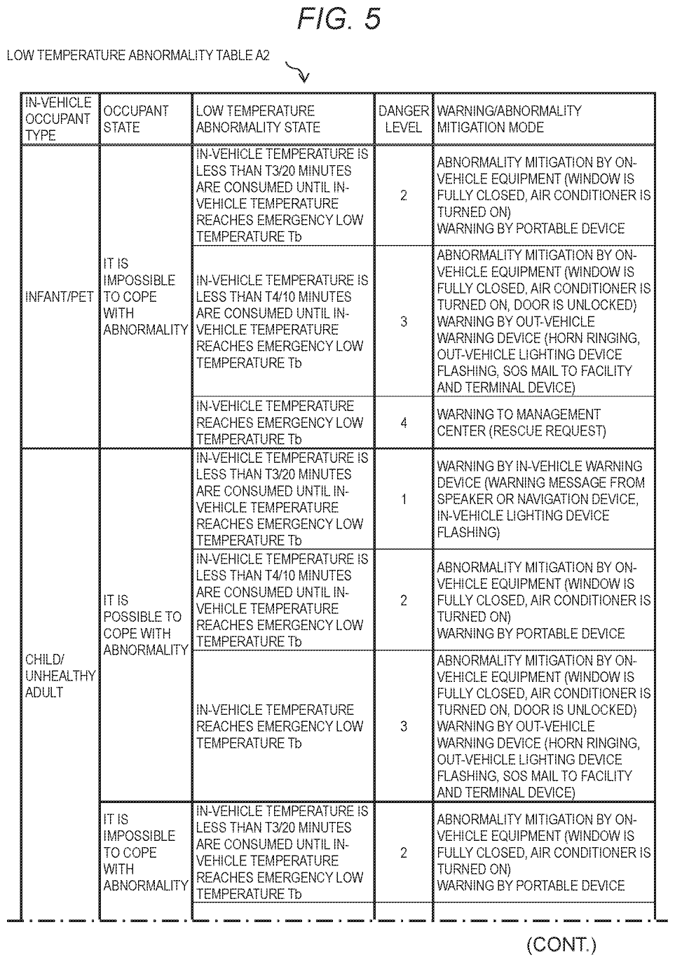

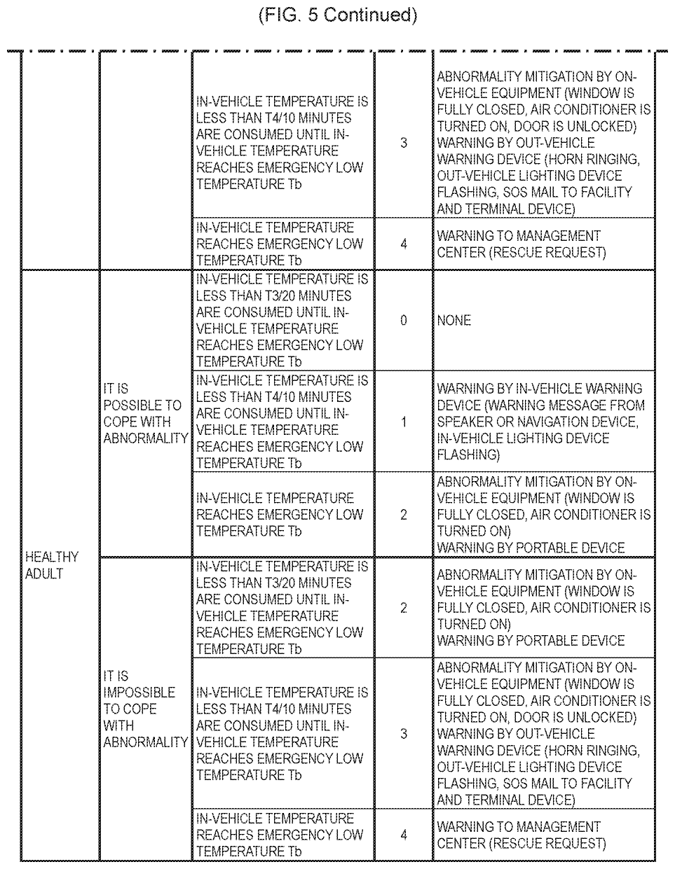

When the abnormality detection unit 1b detects that the inside of the vehicle has the low temperature abnormality in step S11 of FIG. 3, the control unit 1 executes the warning and abnormality mitigation processing of step S13 of FIG. 3, according to the low temperature abnormality table A2 illustrated in FIG. 5. In the low temperature abnormality table A2, a low temperature abnormality state is set instead of the high temperature abnormality state in the high temperature abnormality table A1 of FIG. 4.

In FIG. 5, when the occupant in the vehicle is only an infant or a pet, the occupant cannot cope with the abnormality in the vehicle. Thus, when the temperature in the vehicle is lower than a predetermined temperature T3 (for example, 10° C.) or when the estimated time until the temperature in the vehicle reaches an emergency lower temperature

Tb (for example, 0° C.) is 20 minutes, the control unit 1 determines that the danger level is “2”. Further, when the temperature in the vehicle is lower than a predetermined temperature T4 (for example, 5° C., T4<T3) or when the estimated time until the temperature in the vehicle reaches the emergency lower temperature Tb is 10 minutes, the control unit 1 determines that the danger level is “3”. Further, when the temperature in the vehicle reaches the emergency low temperature Tb, the control unit 1 determines that the danger level is “4”.

Further, when the occupant in the vehicle is a child or an unhealthy adult, in a case where the occupant can partially cope with the abnormality in the vehicle, if the temperature in the vehicle is lower than the predetermined temperature T3 or the estimated time until the temperature in the vehicle reaches the emergency low temperature Tb is 20 minutes, the control unit 1 determines that the danger level is “1”. Further, when the temperature in the vehicle is lower than the predetermined temperature T4 or when the estimated time until the temperature in the vehicle reaches the emergency lower temperature Tb is 10 minutes, the control unit 1 determines that the danger level is “2”. Further, when the temperature in the vehicle reaches the emergency low temperature Tb, the control unit 1 determines that the danger level is “3”.

Further, when the occupant in the vehicle is a child or an unhealthy adult, in a case where the occupant cannot cope with the abnormality in the vehicle, if the temperature in the vehicle is lower than the predetermined temperature T3 or the estimated time until the temperature in the vehicle reaches the emergency low temperature Tb is 20 minutes, the control unit 1 determines that the danger level is “2”. Further, when the temperature in the vehicle is lower than the predetermined temperature T4 or when the estimated time until the temperature in the vehicle reaches the emergency lower temperature Tb is 10 minutes, the control unit 1 determines that the danger level is “3”. Further, when the temperature in the vehicle reaches the emergency low temperature Tb, the control unit 1 determines that the danger level is “4”.

Further, when the occupant in the vehicle is a healthy adult, in a case where the occupant can cope with the abnormality in the vehicle, if the temperature in the vehicle is lower than the predetermined temperature T3 or the estimated time until the temperature in the vehicle reaches the emergency low temperature Tb is 20 minutes, the control unit 1 determines that the danger level is “0”. Further, when the temperature in the vehicle is lower than the predetermined temperature T4 or when the estimated time until the temperature in the vehicle reaches the emergency lower temperature Tb is 10 minutes, the control unit 1 determines that the danger level is “1”. Further, when the temperature in the vehicle reaches the emergency low temperature Tb, the control unit 1 determines that the danger level is “2”.

Further, when the occupant in the vehicle is a healthy adult, in a case where the occupant cannot cope with the abnormality in the vehicle, if the temperature in the vehicle is lower than the predetermined temperature 13 or the estimated time until the temperature in the vehicle reaches the emergency low temperature Tb is 20 minutes, the control unit 1 determines that the danger level is “2”. Further, when the temperature in the vehicle is lower than the predetermined temperature 14 or when the estimated time until the temperature in the vehicle reaches the emergency lower temperature Tb is 10 minutes, the control unit 1 determines that the danger level is “3”. Further, when the temperature in the vehicle reaches the emergency low temperature Tb, the control unit 1 determines that the danger level is “4”.

After the determination of the danger levels “0” to “4”, the control unit 1 executes processing (no operation, the abnormality mitigation operation, and the warning operation) corresponding to the danger levels “0” to “4”. The warning and abnormality mitigation mode corresponding to the danger levels “0” to “4” of the low temperature abnormality table A2 of FIG. 5 is substantially the same as the warning and abnormality mitigation mode corresponding to the danger levels “0” to “4” of the high temperature abnormality table A1 illustrated in FIG. 4. However, in the low temperature abnormality table A2 of FIG. 5, the opening and closing body 53 is fully opened at the danger level “2” and the danger level “3”.

### CO Abnormality

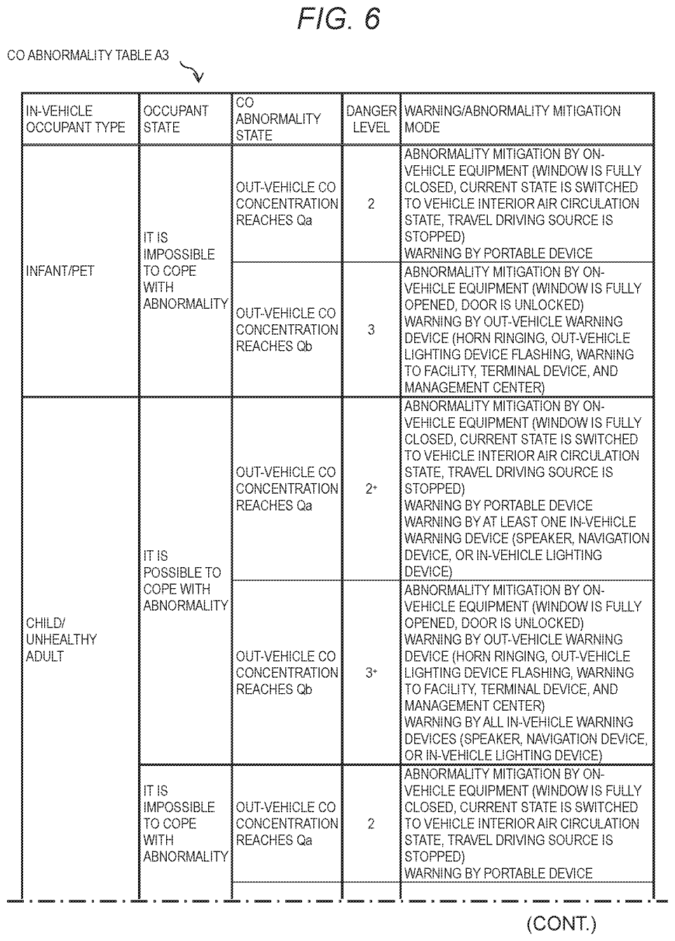

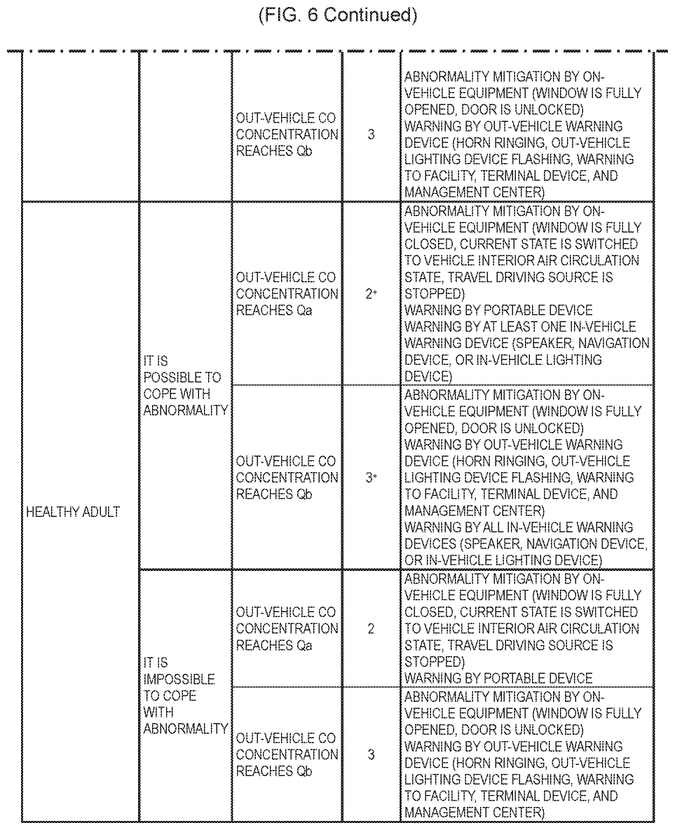

When the abnormality detection unit 1b detects that the inside of the vehicle has the CO abnormality in step S11 of FIG. 3, the control unit 1 executes the warning and abnormality mitigation processing of step S13 of FIG. 3, according to the CO abnormality table A3 illustrated in FIG. 6. In the CO abnormality table A3, abnormal states of the CO concentration outside and inside the vehicle are set as abnormal states.

In FIG. 6, when the occupant in the vehicle is only an infant or a pet, the occupant cannot cope with the abnormality in the vehicle. Thus, when the CO concentration outside the vehicle detected by the CO sensor 6f reaches a predetermined concentration Qa, the control unit 1 determines that the danger level is “2”. At the danger level 2, the control unit 1 causes the opening and closing body control device 42 to fully close the window or switches the air conditioner 41 to an air circulation state in the vehicle interior. Further, when the travelling drive source such as an engine is driven, the travelling drive source is stopped. Further, the alerting light included in the alerting unit 20a of the portable device 20 is lighted in orange, and the fact that the occupant is left in the vehicle, the type and the state of the occupant, and an abnormal state of the CO concentration in the vehicle are displayed on the display included in the alerting unit 20a and are notified by the speaker to alert the user.

Further, when the occupant in the vehicle is only an infant or a pet and the CO concentration in the vehicle detected by the CO sensor 6f reaches a predetermined concentration Qb, the control unit 1 determines that the danger level is “3”. At the danger level 3, the control unit 1 causes the opening and closing control device 42 to fully open the window and causes the locking and unlocking device 44 to unlocks the door of the vehicle 50. Further, the horn 34 and the out-vehicle lighting device 35 are driven to warn the outside of the vehicle. Further, a warning is provided to the facility, the terminal device, or the management center 61 registered in advance via the public communication device 36 and the public communication network 60.

Further, even when the occupant in the vehicle is a child or an unhealthy adult or a healthy adult, in a case where the occupant can partially cope with the abnormality in the vehicle, if the CO concentration outside the vehicle reaches the predetermined concentration Qa, the control unit 1 determines that the danger level is “2⁺”. At the danger level “2⁺”, the control unit 1 drives at least one of the in-vehicle warning devices 31 to 33 in addition to the abnormality mitigation operation and the out-vehicle warning operation corresponding to the danger level “2”, and warns the occupant in the vehicle. At this time, since the CO concentration outside the vehicle is high, a recommendation to stay in the vehicle without opening the opening and closing body 43 may be notified to the occupant in the vehicle.

Further, even when the occupant in the vehicle is a child or an unhealthy adult or a healthy adult, in a case where the occupant can partially cope with the abnormality in the vehicle, if the CO concentration inside the vehicle reaches the predetermined concentration Qb, the control unit 1 determines that the danger level is “3⁺”. At the danger level “3⁺”, the control unit 1 drives all the in-vehicle warning devices 31 to 33 to warn the occupant in the vehicle in addition to performing the abnormality mitigation operation and the out-vehicle warning operation corresponding to the danger level “3”. At this time, since the CO concentration inside the vehicle is high, a warning having a larger scale than that of the warning to the inside of the vehicle corresponding to the danger level “2⁺” is performed.

Further, even when the occupant in the vehicle is a child or an unhealthy adult or a healthy adult, in a case where the occupant cannot cope with the abnormality in the vehicle, if the CO concentration outside the vehicle reaches the predetermined concentration Qa, the control unit 1 determines that the danger level is “2”. Further, when the CO concentration inside the vehicle reaches the predetermined concentration Qb, the control unit 1 determines that the danger level is “3”. After it is determined that the danger level is “2” or “3”, the control unit 1 executes the abnormality mitigation operation or the warning operation corresponding to each danger level, as described above.

### Inundation Abnormality

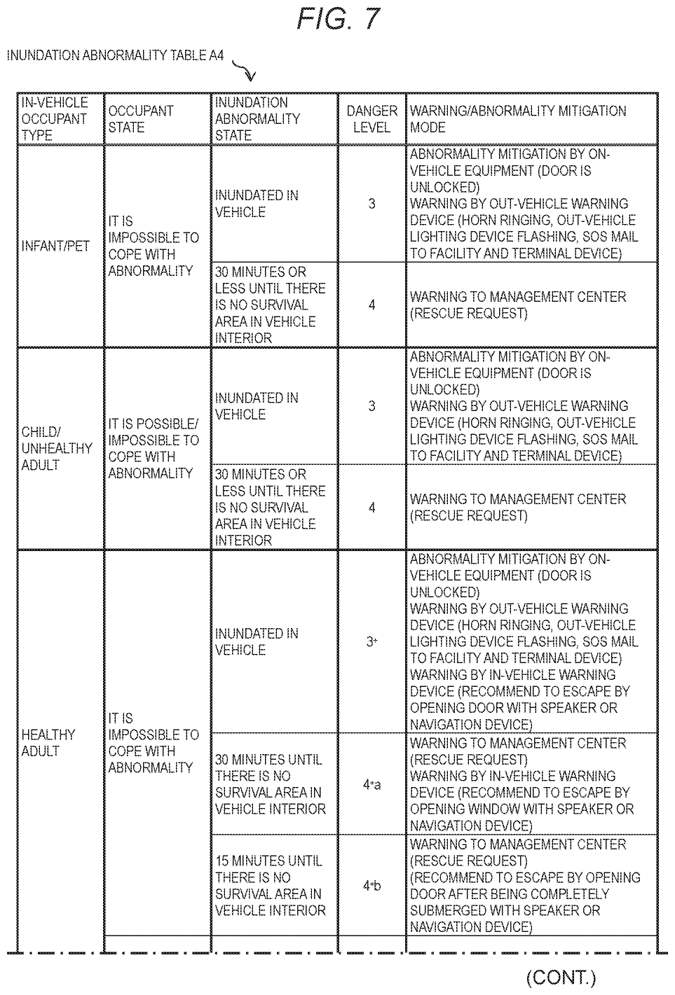

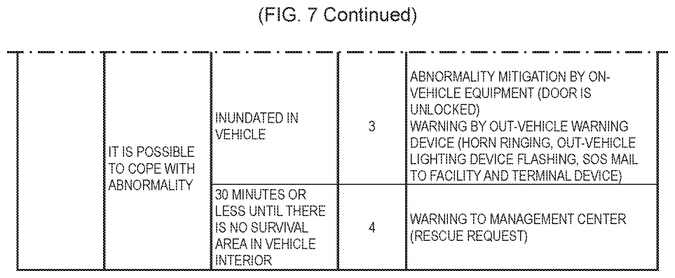

When the abnormality detection unit 1b detects that the inside of the vehicle has the inundation abnormality in step S11 of FIG. 3, the control unit 1 executes the warning and abnormality mitigation processing of step S13 of FIG. 3, according to the inundation abnormality table A4 illustrated in FIG. 7. In the inundation abnormality table A4, an inundation state inside the vehicle is set as an abnormal state.

In FIG. 7, when the occupant in the vehicle is only an infant or a pet or when the occupant in the vehicle is a child or an unhealthy adult, if the inundation sensor 6g detects inundation into the vehicle regardless of whether or not the occupant can cope with the abnormality in the vehicle, the control unit 1 determines that the danger level is “3”. At the danger level “3”, the control unit 1 unlocks the door of the vehicle 50 by the locking and unlocking device 44. Further, the horn 34 and the out-vehicle lighting device 35 are driven to warn the outside of the vehicle. Further, the SOS mail is transmitted to the facility or the terminal device, which are registered, via the public communication device 36 and the public communication network 60. Further, the abnormality detection unit 1b estimates the time until there is no living area in the vehicle interior, based on a result of the detection by the inundation sensor 6g. When the time is 30 minutes or less, the control unit 1 determines that the danger level is “4”. At the danger level “4”, the control unit 1 warns the management center 61 to request a rescue, via the public communication device 36 and the public communication network 60.

Further, when the occupant in the vehicle is a healthy adult and the occupant cannot cope with the abnormality in the vehicle, if the inundation sensor 6g detects the inundation into the vehicle, the control unit 1 determines that the danger level is “3”. Further, when the estimated time until there is no living area. In the vehicle interior is 30 minutes or less, the control unit 1 determines that the danger level is “4”. After it is determined that the danger level is “3” or “4”, as described above, the abnormality mitigation operation or the warning operation corresponding to each danger level are executed.

Further, when the occupant in the vehicle is a healthy adult and the occupant can cope with the abnormality in the vehicle, if the inundation sensor 6g detects the inundation into the vehicle, the control unit 1 determines that the danger level is “3⁺”. At the danger level “3⁺”, the control unit 1 warns the occupant in the vehicle by the in-vehicle warning devices 31 and 32 in addition to performing the abnormality mitigation operation and the warning operation corresponding to the danger level “3”. At this time, it is recommended by the speaker 31 or the navigation device 32 to open the door of the vehicle 50 and escape from the vehicle 50.

Further, when the occupant in the vehicle is a healthy adult and the occupant can cope with the abnormality in the vehicle, if the estimated time until there is no living area in the vehicle interior is 30 minutes, the control unit 1 determines that the danger level is “4⁺a”. At this time, although the door of the vehicle 50 may not be opened due to the water pressure of the invaded water, the window may be opened. Therefore, at the danger level “4⁺a”, the control unit 1 makes a recommendation to the occupant in the vehicle by the speaker 31 or the navigation device 32 to open the window of the vehicle 50 and escape from the vehicle 50 in addition to performing the above-described warning operation of the danger level “4”.

Further, when the occupant in the vehicle is a healthy adult and the occupant can cope with the abnormality in the vehicle, if the estimated time until there is no living area in the vehicle interior is 15 minutes, the control unit 1 determines that the danger level is “4⁺b”. At this time, there is a possibility that neither the door nor the window of the vehicle 50 is opened due to the water pressure of the invaded water. Therefore, at the danger level “4⁺b”, the control unit 1 makes a recommendation to the occupant in the vehicle by the speaker 31 or the navigation device 32 to open the window and escape from the vehicle 50 after the vehicle 50 is completely submerged in addition to performing the above-described warning operation of the danger level “4”.

### Traffic Accident Abnormality

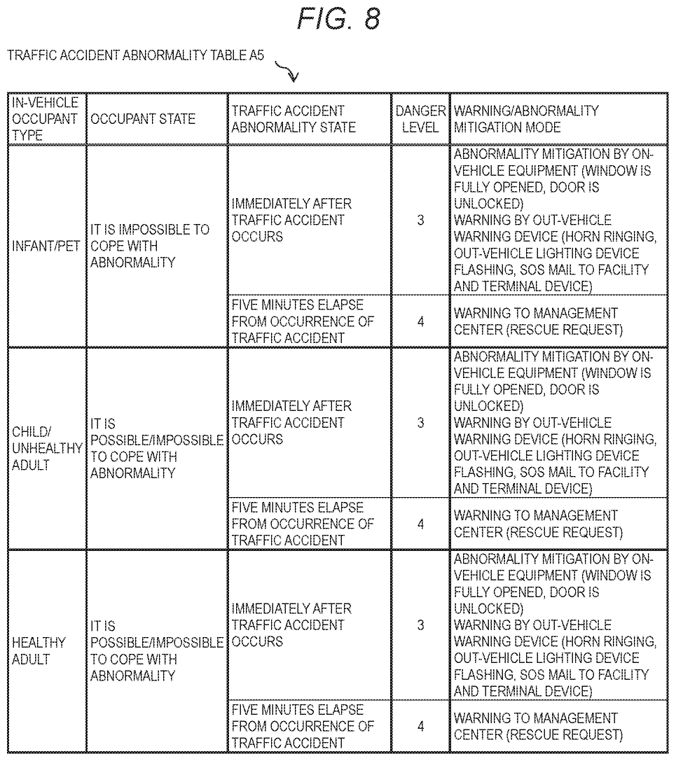

When the abnormality detection unit 1b detects that the inside of the vehicle has the traffic abnormality by a traffic accident in step S11 of FIG. 3, the control unit 1 executes the warning and abnormality mitigation processing of step S13 of FIG. 3, according to the traffic accident abnormality table A5 illustrated in FIG. 8. In the traffic accident abnormality table A5, a traffic accident state is set as an abnormal state.

When a traffic accident occurs, the occupant in the vehicle may not move or may be injured. Further, the occupant may be dangerous when the occupant goes outside the vehicle immediately after the traffic accident. Therefore, as illustrated in FIG. 8, even when the occupant in the vehicle is only an infant or a pet, a child or an unhealthy adult, or a healthy adult, regardless of whether or not the occupant can cope with the abnormality in the vehicle, immediately after the shock sensor 6h and the airbag sensor 6i detect that the traffic accident occurs, the control unit 1 determines that the danger level is “3”. At the danger level “3”, the control unit 1 fully opens the window by the opening and closing body control device 42, and unlocks the door of the vehicle 50 by the locking and unlocking device 44. Further, the horn 34 and the out-vehicle lighting device 35 are driven to warn the outside of the vehicle. Further, the SOS mail is transmitted to the facility or the terminal device, which are registered in advance, via the public communication device 36 and the public communication network 60. When 5 minutes have elapsed from the occurrence of the traffic accident, the control unit 1 determines that the danger level is “4”. At the danger level “4”, the control unit 1 warns the management center 61 to request a rescue, via the public communication device 36 and the public communication network 60.

As described above, in step S13 of FIG. 3, the warning and abnormality mitigation processing (FIGS. 4 to 8) is performed according to the type and the danger level of the abnormal state occurring in the vehicle. When this processing is completed, the control unit 1 identifies whether or not a predetermined release manipulation has been performed (step S14 of FIG. 3). This release manipulation is a predetermined manipulation performed by any person with respect to the vehicle 50 in order to release the above-described warning by the warning devices 31 to 36 or rescue the occupant in the vehicle. In detail, examples of the release manipulation include a manipulation of opening the door of the vehicle 50, a manipulation of turning on the power source, a manipulation of starting the travelling drive source such as an engine, a manipulation of stopping the warning by the warning devices 31 to 36, or the like. While such a release manipulation is not performed (step S14: NO), the control unit 1 executes the processing after step S11 again. That is, since the abnormality in the vehicle is repeatedly detected, the abnormality mitigation operation or the warning operation is executed according to the change of the abnormality.

When the release manipulation is performed (step S14: YES), the operation is completed. Thereafter, the processing after step S1 is executed again.

According to the above-described embodiment, in the in-vehicle accident prevention device 10, based on the image data of the image captured by the camera 7, the result of the detection by the biosensor 6a, and the sound signal from the microphone 8, the occupant detection unit 1a not only detects the occupant in the vehicle but also extracts the physical characteristics or behavioral characteristics of the occupant so as to detect the type of the occupant and whether or not the occupant copes with the abnormality. When the occupant detection unit 1a detects the occupant in the vehicle and the abnormality detection unit 1b detects the abnormality in the vehicle, according to the type or the state of the occupant detected by the occupant detection unit la, the warning devices 31 to 36 warn the inside or the outside of the vehicle and the on-vehicle equipment 41 to 44 mitigates the abnormality in the vehicle. Therefore, according to the occupant left in the vehicle in the abnormal state, the warning or the abnormal mitigation can be properly performed.

Further, in the above-described embodiment, when the occupant left in the vehicle in the abnormal state is a healthy adult who can detect the abnormality and perform appropriate measures such as escaping from the vehicle to the outside by himself/herself, the warning by the warning devices 31 to 36 and the abnormality mitigation by the on-vehicle equipment 41 to 44 are not executed. Therefore, it is possible to suppress consumption of the battery 40 of the vehicle 50 for driving the warning devices and the on-vehicle equipment, and to suppress a state in Which the warning becomes noise.

Further, in the above-described embodiment, even when the occupant left in the vehicle in the abnormal state is a healthy adult or the like, in a case where the occupant cannot cope with the abnormality in the vehicle due to deep sleeping, the warning devices 31 to 33 in the vehicle warn the occupant. Therefore, the occupant such as a healthy adult is awakened by the warning, recognizes the abnormality in the vehicle, and properly copes with the abnormality in the vehicle by himself/herself, so that the traffic accident can be prevented.

Further, in the above-described embodiment, when the occupant left in the vehicle in the abnormal state is an infant or a pet which cannot cope with the abnormality by himself/herself, the warning to the outside of the vehicle by the warning devices 31 to 36 and the abnormality mitigation by the on-vehicle equipment 41 to 44 are executed. Therefore, it is possible to request a rescue of the occupant who cannot cope with the abnormality in the vehicle by himself/herself from a person who exists outside the vehicle or to rescue the occupant by mitigating or resolving the abnormality in the vehicle, so that an accident in the vehicle can be prevented.

Further, in the above-described embodiment, the abnormality detection unit 1b repeatedly detects a plurality of types of abnormalities in the vehicle. According to the result of the detection by the abnormality detection unit 1b, the warning by the warning devices 31 to 36 and the abnormality mitigation by the on-vehicle equipment 41 to 44 are executed. Therefore, according to the change of the abnormality in the vehicle in which the occupant is left, the warning and the abnormality mitigation can be appropriately executed.

Further, in the above-described embodiment, the danger level of in the vehicle is determined based on the type and the state of the occupant in the vehicle and the abnormal state in the vehicle. The warning by the warning devices 41 to 44 and the abnormality mitigation by the on-vehicle equipment 31 to 36 are selected according to the danger level.

Therefore, it is possible to reliably execute the appropriate warning or the abnormality mitigation according to the danger level in the vehicle.

Further, in the above-described embodiment, the alerting unit 20a of the portable device 20 alerts the user carrying the portable device 20 according to the type and the state of the occupant in the vehicle and the abnormal state in the vehicle. Therefore, when the occupant is left in the vehicle in the abnormal state, by the alerting from the alerting unit 20a of the portable device 20, the user can perform appropriate measures such as returning to the vehicle 50 to rescue the occupant or requesting a rescue from another person.

Further, in the above-described embodiment, when the occupant left in the vehicle in the abnormal state cannot cope with the abnormality, if the portable device 20 goes out from the vehicle 50, the alerting unit 20a alerts the user carrying the portable device 20. Therefore, in a state in which the occupant who cannot cope with the abnormality in the vehicle is left in the vehicle, the user of the vehicle 50 carrying the portable device 20 can be prevented from leaving the vehicle 50, and the accident in the vehicle can be prevented in advance.

Further, in the above-described embodiment, a return time during which the user carrying the portable device 20 returns to the vehicle 50 is estimated from the position of the portable device 20 outside the vehicle. According to the return time, the alerting by the alerting unit 20a of the portable device 20, the warning by the warning devices 31 to 36, or the abnormality mitigation by the on-vehicle equipment 41 to 44 is executed. Thus, it is possible to more appropriately perform the warning and the abnormality mitigation. For example, as the return time becomes longer, the scale (the number of driven devices, and the frequency, the contents, and the number of times of the alerting and warning) of the alerting by the alerting unit 20a and the warning by the warning devices 31 to 36 becomes larger or the scale (the number of driven devices, drive power, and the like) of the abnormality mitigation by the on-vehicle equipment 41 to 44 becomes larger. Thus, the rescue of the occupant left in the vehicle in the abnormal state can be promoted. Further, as the return time becomes shorter, the scales of the alerting by the alerting unit 20a and the warning by the warning devices 31 to 36 becomes smaller or the scale of the abnormality mitigation by the on-vehicle equipment 41 to 44 becomes smaller. Thus, power consumption and noise of a cell or the battery 40 of the portable device 20 can be suppressed.

Further, in the above-described embodiment, in a state in which the occupant is left in the vehicle in the high temperature abnormality, the low temperature abnormality, or the inundation abnormality, an arrival time until the abnormality reaches a predetermined emergency level (the emergency high temperature Ta, the emergency low temperature Tb, and the CO concentrations Qa and Qb) is estimated. According to the arrival time, the alerting by the alerting unit 20a of the portable device 20, the warning by the warning devices 31 to 36, or the abnormality mitigation by the on-vehicle equipment 41 to 44 is executed. Thus, it is possible to more appropriately perform the warning and the abnormality mitigation. For example, as the arrival time becomes longer, the scales of the alerting by the alerting unit 20a and the warning by the warning devices 31 to 36 becomes smaller or the scale of the abnormality mitigation by the on-vehicle equipment 41 to 44 becomes smaller. Thus, power consumption and noise of a cell or the battery 40 of the portable device 20 can be suppressed. Further, as the arrival time becomes shorter, the scales of the alerting by the alerting unit 20a and the warning by the warning devices 31 to 36 becomes larger or the scale of the abnormality mitigation by the on-vehicle equipment 41 to 44 becomes larger. Thus, the rescue of the occupant left in the vehicle in the abnormal state can be promoted.

Further, in the above-described embodiment, when the occupant is left in the vehicle in the abnormal state, a warning by the warning devices 31 to 33 in the vehicle is provided to the occupant, so that the occupant can escape from the vehicle to the outside by himself/herself and the abnormal state in the vehicle can be resolved by a predetermined vehicle manipulation. Further, by warning a person outside the vehicle by the out-vehicle warning devices 34 to 36, the person outside the vehicle can be urged to rescue the occupant in the vehicle. Further, the abnormal state in the vehicle can be mitigated or relieved by opening and closing the opening and closing body 43 automatically or air-conditioning the inside of the vehicle by the air conditioner 41.

The present invention may adopt various embodiments other than the above-described embodiment.

For example, in the above-described embodiment, the position of the vehicle 50 is detected by the GPS 47. However, the position of the vehicle 50 can be detected by a smartphone constituting the portable device 20 using a GPS function of the smartphone.

Further, in the above-described embodiment, a distance from the vehicle 50 to the portable device 20 is calculated based on a reception intensity of a signal from the portable device 20 received by the wireless communication unit 5. However, a distance from the vehicle 50 to the smartphone can be calculated using the GPS function of the smartphone constituting the portable device 20. In detail, the smartphone detects a position thereof by the GPS function, and transmits the position information to the in-vehicle accident prevention device 10. In the in-vehicle accident prevention device 10, the position detection unit 1c calculates the distance from the vehicle 50 to the smartphone, based on the position information of the smartphone received by the wireless communication unit 5 and the position of the vehicle 50 detected by the GPS 47. Alternatively, the distance from the vehicle 50 to the smartphone may be calculated using a map application mounted on the smartphone. Further, the smartphone may calculate the distance from the vehicle 50 to the smartphone, based on a wireless communication state (a signal reception intensity, a signal reception interval, or the like) with the in-vehicle accident prevention device 10. The distance information may be transmitted to the in-vehicle accident prevention device 10 or may be displayed on a display of the smartphone.

Further, in the above-described embodiment, an example where the occupant detection unit 1a detects the occupant in the vehicle and the type and the state of the occupant, based on the image captured by the camera 7, the result of the detection by the biosensor 6a, and the output signal from the microphone 8, is illustrated. However, the present invention is not limited thereto. In addition, for example, the occupant in the vehicle or the type or the state of the occupant may be detected based on one or more of the image captured by the camera 7, the result of the detection by the biosensor 6a, and the output signal from the microphone 8. Further, biometric information detected by the biosensor Ca may be information other than the biometric information listed above. Further, the detected type and the detected state of the occupant are not limited to those illustrated in FIGS. 4 to 8, and may be set as appropriate.

Further, in the above-described embodiment, an example where the high temperature abnormality, the low temperature abnormality, the CO abnormality, the inundation abnormality, and traffic abnormality in the vehicle are detected by sensors 6a to 6i illustrated in FIG. 2. However, sensors other than these sensors may be used to detect the above-described five abnormalities in the vehicle or the other abnormalities in the vehicle. Further, physical quantities such as the temperature, the concentration, and the time serving as standards for detecting the high temperature abnormality, the low temperature abnormality, the CO abnormality, and the inundation abnormality are not limited to the numerical values, and may be set as appropriate. Further, conditions for detecting changes in the respective abnormalities can be set as appropriate.

Further, the warning devices for providing a warning to the inside and the outside of the vehicle and the on-vehicle equipment for mitigating the abnormality in the vehicle are not limited to the warning devices 31 to 36 and the on-vehicle equipment 41 to 44 which are illustrated in the above-described embodiment, and other devices may be used for the warning devices and the on-vehicle equipment. Further, the numbers of the warning devices and the on-vehicle equipment, the warning modes by the warning devices, the abnormality mitigation modes by the on-vehicle equipment, and the like are not limited to those illustrated in the embodiment, and can be set as appropriate. Further, the type and the number of the portable devices 20 and the alerting mode of the alerting unit 20a may be set as appropriate. Further, the in-vehicle accident prevention system may be provided with at least one of the alerting unit of the portable device, the in-vehicle warning device for providing a warning to the inside of the vehicle, the out-vehicle warning device for providing a warning to the outside of the vehicle, and the on-vehicle equipment for mitigating the abnormalities in the vehicle.

Further, in the above-described embodiment, an example Where the present invention is applied to the in-vehicle accident prevention device 10 and the in-vehicle accident prevention system 100 for preventing the accident in the vehicle 50 including a four-wheeled vehicle has been described. However, the present invention can be applied even to the in-vehicle accident prevention device and the in-vehicle accident prevention system mounted on other vehicles.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. An in-vehicle accident prevention device comprising:
an occupant detection unit that detects an occupant inside a vehicle;
an abnormality detection unit that detects an abnormality in the vehicle; and
a control unit that controls a warning device to warn an inside or an outside of the vehicle or controls on-vehicle equipment to mitigate the abnormality when the occupant detection unit detects the occupant and the abnormality detection unit detects the abnormality,
wherein the occupant detection unit extracts physical characteristics or behavioral characteristics of the occupant to further detect a type of the occupant or whether or not the occupant is able to cope with the abnormality, and
wherein the control unit executes the warning by the warning device and the abnormality mitigation by the on-vehicle equipment according to a result of the detection by the occupant detection unit.

2. The in-vehicle accident prevention device according to claim 1,
wherein the control unit executes the warning for the outside of the vehicle by the warning device or executes the abnormality mitigation by the on-vehicle equipment when the occupant detection unit detects that the occupant in the vehicle is not able to cope with the abnormality.

3. The in-vehicle accident prevention device according to claim 1,
wherein the abnormality detection unit repeatedly detects a plurality types of abnormalities in the vehicle, and
wherein the control unit executes the warning by the warning device or the abnormality mitigation by the on-vehicle equipment, according to a result of the detection by the abnormality detection unit.

4. The in-vehicle accident prevention device according to claim 3,
wherein there are a plurality of warning operations by the warning device and a plurality of abnormality mitigation operations by the on-vehicle equipment, and
wherein the control unit determines a danger level in the vehicle, based on results of the detection by the occupant detection unit and the abnormality detection unit, and selects a predetermined operation among the plurality of warning operations or the plurality of abnormality mitigation operations, according to the danger level.

5. The in-vehicle accident prevention device according to claim 1, further comprising:
a wireless communication unit that is mounted on the vehicle to communicate with a portable device carried by a user of the vehicle,
wherein the control unit communicates with the portable device by the wireless communication unit, and executes an alerting to the user by an alerting unit provided in the portable device according to the results of the detection by the occupant detection unit and the abnormality detection unit.

6. The in-vehicle accident prevention device according to claim 5, further comprising:
a position detection unit that detects a position of the portable device, based on a communication state with the portable device by the wireless communication unit,
wherein the control unit executes the alerting by the alerting unit when the occupant detection unit detects that the occupant in the vehicle is not able to cope with the abnormality and it is determined that the portable device is separated from the vehicle, based on a result of the detection by the position detection unit.

7. The in-vehicle accident prevention device according to claim 6,
wherein the control unit estimates a time, during which the user carrying the portable device is able to return to the vehicle, from the position of the portable device outside the vehicle detected by the position detection unit, and executes the alerting by the alerting unit, the warning by the warning device, or the abnormality mitigation by the on-vehicle equipment, according to the time.

8. The in-vehicle accident prevention device according to claim 5,
wherein the control unit estimates a time until the abnormality reaches a predetermined emergency level, based on results of the detection by the occupant detection unit and the abnormality detection unit, and executes the alerting by the alerting unit, the warning by the warning device, or the abnormality mitigation by the on-vehicle equipment according to the time.

9. An in-vehicle accident prevention system comprising:
the in-vehicle accident prevention device according to claim 1; and
a warning device that warns an inside or an outside of a vehicle or on-vehicle equipment that mitigates abnormality in the vehicle.

10. The in-vehicle accident prevention system according to claim 9,
wherein the warning device includes an in-vehicle warning device that warns an occupant in the vehicle that the inside of the vehicle is abnormal, or an out-vehicle warning device that warns the outside of the vehicle that the occupant is left in the vehicle which is abnormal, and
wherein the on-vehicle equipment includes an opening and closing body control device that opens and closes an opening and closing body of the vehicle or an air conditioner that air-conditions the inside of the vehicle.
